(19) United States
(12) Patent Application Publication
(10) Pub. No.: US 2025/0014338 A1
(43) Pub. Date: Jan. 9, 2025

(54) OBJECT-CENTRIC VIDEO REPRESENTATION FOR ACTION PREDICTION

(71) Applicants: Honda Motor Co., Ltd., Tokyo (JP); Brown University, Providence, RI (US)

(72) Inventors: CE ZHANG, Chapel Hill, NC (US); CHANGCHENG FU, Los Angeles, CA (US); SHIJIE WANG, Providence, RI (US); NAKUL AGARWAL, San Francisco, CA (US); KWONJOON LEE, San Jose, CA (US); CHIHO CHOI, San Jose, CA (US); CHEN SUN, Providence, CA (US)

(73) Assignees: Honda Motor Co., Ltd., Tokyo (JP); Brown University, Providence, RI (US)

(21) Appl. No.: 18/539,590

(22) Filed: Dec. 14, 2023

Related U.S. Application Data
(60) Provisional application No. 63/511,825, filed on Jul. 3, 2023.

(51) Int. Cl. G06V 20/40; G06V 10/774; G06V 10/94; G06V 40/20

(52) U.S. Cl. CPC G06V 20/41; G06V 10/774; G06V 10/945; G06V 20/46; G06V 40/20; G06V 10/82

(57) ABSTRACT

An electronic device and method for object-centric video representation for action prediction is provided. The electronic device extracts a first sequence of video segments from video content associated with a domain and detects a set of objects in the first sequence of video segments. The electronic device generates a set of embeddings based on the first sequence of video segments and the set of objects. The electronic device applies a PTE model on the set of embeddings. The electronic device predicts, based on the application, a set of object-action pairs associated with a second sequence of video segments of the video content. Each object-action pair includes an action to be executed using an object of the set of objects in a video segment of the second sequence of video segments. The second sequence of video segments succeeds the first sequence of video segments in a timeline of the video content.

### CROSS-REFERENCE TO RELATED APPLICATIONS/INCORPORATION BY REFERENCE

This Application makes reference to U.S. Provisional Application Ser. No. 63/511,825, which was filed on Jul. 3, 2023. The above stated Patent Application is hereby incorporated herein by reference in its entirety.

### BACKGROUND

Advancements in artificial intelligence and computer vision technologies have led to development of object-based video recognition frameworks that have a capability to detect, by use of object-detectors, objects in different frames of a video and anticipate one or more future actions associated with the detected objects. The object-based video recognition frameworks may include modules which may analyze current video frames to determine or recognize one or more current actions from the current video frames, and, thereafter, predict future actions based on the recognized one or more current actions. For prediction of such future actions, it may be necessary to leverage object detectors which may be trained based on bounding box annotations associated with objects in the video frames. This is due to the ability of object representations to concisely describe cluttered scenes based on the objects within them. Moreover, objects may serve as crucial indicators for identifying and predicting human actions, given their relevance to the tools and objectives of those actions. Hence, a training dataset associated with the object detectors may be required to include the objects of the current video frames, to be able to leverage the object detectors for action prediction tasks associated with recognition of the objects. However, bounding box annotation may be time-consuming and costly, particularly in large datasets or densely populated scenes. As such, scaling of the object-based video recognition frameworks for analysis of complex scenes (rendered by the video frames), cluttered scenes, or scenes with a greater visual diversity may either be infeasible or cumbersome. Such lack of scalability and flexibility may have an impact on accuracy of object detection and, subsequently, video-based action anticipation.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device for object-centric video representation for action prediction is provided. The electronic device may include circuitry that may extract a first sequence of video segments from video content associated with a domain. In the extracted first sequence of video segments, the circuitry may detect a set of objects. Based on the extracted first sequence of video segments and the detected set of objects, the circuitry may generate a set of embeddings. Thereafter, the circuitry may apply a predictive transformer encoder (PTE) model on the generated set of embeddings. Based on the application of the PTE model, the circuitry may predict a set of object-action pairs associated with a second sequence of video segments of the video content. Each object-action pair of the predicted set of object-action pairs may include an action that is to be executed using an object of the detected set of objects included in a video segment of the second sequence of video segments. The second sequence of video segments may succeed the first sequence of video segments in a playback timeline of the video content. Finally, the circuitry may render information associated with the predicted set of object-action pairs and the second sequence of video segments.

According to another embodiment of the disclosure, a method of object-centric video representation for action prediction is provided. The method may include extracting a first sequence of video segments from video content associated with a domain. The method may further include detecting a set of objects in the first sequence of video segments. The method may further include generating a set of embeddings based on the extracted first sequence of video segments and the detected set of objects. The method may further include applying a PTE model on the generated set of embeddings. The method may further include predicting, based on the application of the PTE model, a set of object-action pairs associated with a second sequence of video segments of the video content. Each object-action pair of the predicted set of object-action pairs may include an action that is to be executed using an object of the detected set of objects included in a video segment of the second sequence of video segments. The second sequence of video segments may succeed the first sequence of video segments in a playback timeline of the video content. The method may further include rendering information associated with the predicted set of object-action pairs and the second sequence of video segments.

According to another embodiment of the disclosure, a non-transitory computer-readable medium is provided. The non-transitory computer-readable medium may have stored thereon computer-implemented instructions that, when executed by an electronic device, causes the electronic device to execute operations. The operations may include extracting a first sequence of video segments from video content associated with a domain. The operations may further include detecting a set of objects in the first sequence of video segments. The operations may further include generating a set of embeddings based on the extracted first sequence of video segments and the detected set of objects. The operations may further include applying a PTE model on the generated set of embeddings. The operations may further include predicting, based on the application of the PTE model, a set of object-action pairs associated with a second sequence of video segments of the video content. Each object-action pair of the predicted set of object-action pairs may include an action that is to be executed using an object of the detected set of objects included in a video segment of the second sequence of video segments. The second sequence of video segments may succeed the first sequence of video segments in a playback timeline of the video content. The operations may further include rendering information associated with the predicted set of object-action pairs and the second sequence of video segments.

### BRIEF DESCRIPTION OF THE DRAWINGS

FIG. 1 is a diagram that illustrates an exemplary network environment for generation of an object-centric video representation for action prediction, in accordance with an embodiment of the disclosure.

FIG. 2 is a block diagram that illustrates an exemplary electronic device that generates an object-centric video representation for action prediction, in accordance with an embodiment of the disclosure.

FIG. 3 is a diagram that illustrates an exemplary execution pipeline for generation of an object-centric video representation for action prediction, in accordance with an embodiment of the disclosure.

FIG. 4 is an exemplary scenario diagram that illustrates prediction of a set of object-action pairs associated with a second sequence of video segments based on a set of object-action labels associated with a first second sequence of video segments, in accordance with an embodiment of the disclosure.

FIG. 5 is a flowchart that illustrates exemplary operations for generation of an object-centric video representation for future action prediction, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic device and method for object-centric video representation for action prediction. Exemplary aspects of the disclosure may provide an electronic device (such as a smart phone, desktop, a laptop, a mainframe computer, and so on) to generate object-centric video representations based on application of a pretrained vision-language model on a set of video segments. Subsequently, human-object interactions associated with another set of video segments may be predicted based on the object-centric representations by use of a transformer-based neural architecture. Specifically, the electronic device may extract a first sequence of video segments from video content (such as, a video file) that may be associated with a domain (such as, a kitchen domain). The electronic device may detect a set of objects (such as, objects that may be present in a kitchen) in the first sequence of video segments. The electronic device may generate a set of embeddings (such as, embeddings associated with each video segment of the first sequence of video segments and each object of the set of objects) based on the extracted first sequence of video segments and the detected set of objects. The electronic device may apply a predictive transformer encoder (PTE) model on the generated set of embeddings. Based on the application of the PTE model, the electronic device may predict a set of object-action pairs associated with a second sequence of video segments of the video content. Each object-action pair of the predicted set of object-action pairs may include an action that is to be executed using an object of the detected set of objects included in a video segment of the second sequence of video segments. The second sequence of video segments may succeed the first sequence of video segments in a playback timeline of the video content. The electronic device may render information associated with the predicted set of object-action pairs (such as, video segments of the second sequence of video segments that may include objects using which actions of the object-action pairs may be performed) and the second sequence of video segments.

Typically, an action anticipation task may involve generation of a sequence of actions that are likely to be performed, by a human or an intelligent agent, using objects that may be detected in frames of a video. The generation of the sequence of actions may be dependent on leveraging of an object detector that is trained on in-domain bounding box annotation. The objects may be associated with a specific domain and specific actions may be performed using the set of objects. Thus, the frames of the video may be annotated with bounding boxes around one or more objects, that may be detected in the frames of the video. The detection of one or more objects may allow recognition or prediction of future human-object or intelligent agent (for example, a robot)-object interactions. However, the in-domain bounding box annotation can be expensive and susceptible to annotation errors and biases, especially in large datasets or frames depicting heavily populated scenes. Therefore, scaling an object-based video recognition framework to an in-domain bounding box annotation on visually diverse frames, or frames that render complex or cluttered scenes, may be infeasible or challenging.

The issues associated with object-based video recognition frameworks may be avoided by relying on an attention mechanism. An attention network that actualizes the attention mechanism may be applied directly on patches of the frames of the video for determination of salient regions in the frames with a weak supervision on action labels. The salient regions may include objects of interest. Although, flexibility of the attention network may be greater compared to the object-based video recognition framework, the attention network may not incorporate information associated with locations of objects of interest that are to be detected in the frames of the video. As such, the determined salient regions may not include any object of interest or include objects that are not the objects of interest, especially when training data used to train the attention network is limited.

To address the above-mentioned issues, the disclosed electronic device may be configured to leverage a pretrained visual-language model for detection of objects, which may be associated with a specific domain, in a first sequence of video segments. For such detection, the pretrained visual-language model may be queried using an object prompt. The set of objects, that are to be detected, may be included in the object prompt. Based on the queried object prompt, an object-centric representation may be generated as output of the pretrained visual-language model for action anticipation. The generation of the output may be based on mapping of each detected object (which may be included in the object prompt) to an action that may be performed by use of the corresponding detected object. The electronic device may further use a transformer encoder network to predict (or anticipate) a set of future actions, which may be performed using objects (i.e., the set of detected objects) included in a second sequence of video segments. The prediction of the set of future actions may be based on multimodal embeddings associated with the first sequence of video segments, the set of objects that are detected in the first sequence of video segments, and timing information associated with the second sequence of video segments. The set of future actions may be predicted or anticipated for execution of a long-term anticipation (LTA) task or execution of a next-action prediction (NAP) task.

Reference will now be made in detail to specific aspects or features, examples of which are illustrated in the accompanying drawings. Wherever possible, corresponding, or similar reference numbers will be used throughout the drawings to refer to the same or corresponding parts.

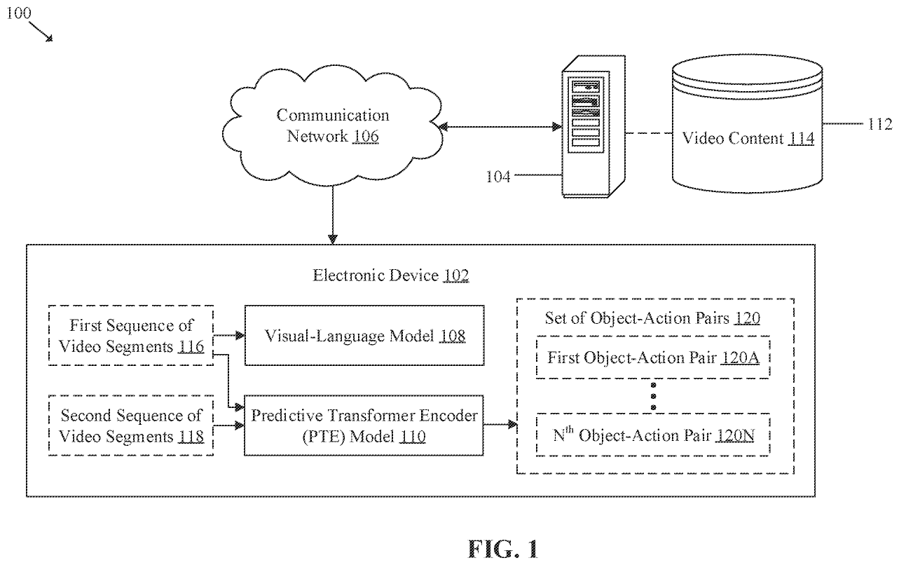

FIG. 1 is a diagram that illustrates an exemplary network environment for generation of an object-centric video representation for action prediction, in accordance with an embodiment of the disclosure. With reference to FIG. 1, there is shown a network environment diagram 100. The network environment 100 may include an electronic device 102 and a server 104. The electronic device 102 may communicate with the server 104 via a communication network 106. In at least one embodiment, the electronic device 102 may include a visual-language model 108 and a predictive transformer encoder (PTE) model 110. In at least one embodiment, the server 104 may include a database 112. The database 112 may include video content 114 (such as, a video file). The visual-language model 108 may receive a first sequence of video segments 116 as input. The PTE model 110 may receive the first sequence of video segments 116 as inputs. The PTE model 110 may predict, for a second sequence of video segments 118, a set of object-action pairs 120 as output. The set of object-action pairs 120 may include a first object-action pair 120A, . . . , and an N^{th} object-action pair 120N.

The electronic device 102 may include suitable logic, circuitry, interfaces, and/or code that may be configured to generate object-centric representations based on detection an object in each video segment of the first sequence of video segments 116. Each detected object may be mapped to an action that may be executed by use of a corresponding detected object for generation of an action label. The action label may be represented as an object-verb pair that corresponds to an object-centric representation. Based on the object-centric representations, multimodal representations, which are inclusive of video segment representations (associated with video segments of the first sequence of video segments 116) and object representations (associated with objects that may be detected in video segments) may be generated. Thereafter, the multimodal representations may be fused across space and time for generation of a set of aggregated features. Based on the aggregated features, the set of object-action pairs 120, indicative of future actions, i.e., actions included in object-action pairs (such as the first object-action pair 120A) to be performed using a objects detected in each video segment of the first sequence of video segments 116, may be predicted. Example implementations the electronic device 102 may include, but are not limited to, a smartphone, a tablet, a laptop, a computing device, a desktop, a mainframe machine, a computer workstation, a virtual reality (VR) device, an augmented reality (AR) device, a mixed reality (MR) device, a machine learning (ML)-capable device (enabled with computing resources, memory resources, network resources, and/or one or more ML models), and/or a consumer electronic (CE) device having a display.

The server 104 may include suitable logic, circuitry, interfaces, and/or code that may be configured to receive a request from the electronic device 102. The request may include an instruction to transmit the video content 114 to the electronic device 102. Upon reception of the request, the server 104 may retrieve the requested video content 114 from the database 112. Thereafter, the server 104 may transmit the video content 114 to the electronic device 102. In some embodiments, the server 104 may include the visual-language model 108 and the PTE model 110. The server may receive the video content 114 from the electronic device 102. On reception of the video content 114, the server 104 may generate the object-centric representations, the multimodal representations, the set of aggregated features, and the set of object-action pairs 120. Thereafter, the server 104 may transmit the set of object-action pairs 120 to the electronic device 102. The server 104 may execute operations through web applications, cloud applications, Hypertext Transfer Protocol (HTTP) requests, repository operations, file transfer, and the like. Example implementations of the server 104 may include, but are not limited to, a database server, a file server, a web server, an application server, a mainframe server, a cloud computing server, or a combination thereof.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102 as separate entities. In certain embodiments, the functionalities of the server 104 may be incorporated in its entirety or at least partially in the electronic device 102, without a departure from the scope of the disclosure.

The communication network 106 may correspond to a communication medium through which the electronic device 102 and the server 104 may communicate with each other. The communication network 106 may be one of a wired connection or a wireless connection. Examples of the communication network 106 may include, but are not limited to, the Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 106 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

Each of the visual-language model 108 and the PTE model 110 may be neural network-based models and may be referred to as a neural network. The neural network may be a computational network or a system of artificial neurons that may typically be arranged in a plurality of layers. The neural network may be defined by its hyper-parameters, for example, activation function(s), a number of weights, a cost function, a regularization function, an input size, a number of layers, and the like. Further, the layers may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Each node in the final layer may be connected with each node of the pre-final layer. Each node in the final layer may receive inputs from the pre-final layer to output a result. The number of layers and the number of nodes in each layer may be determined from the hyper-parameters of the neural network. Such hyper-parameters may be set before or after training of the neural network.

Each node may correspond to a mathematical function (e.g., a sigmoid function or a rectified linear unit) with parameters that are tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function. In training of the neural network, one or more parameters of each node of the neural network may be updated based on whether an output of the final layer for a given input (from the training dataset) matches a correct result in accordance with a loss function for the neural network. The above process may be repeated for the same or a different input until a minimum of the loss function is achieved, and a training error is minimized. Several methods for training are known in art, for example, gradient descent, stochastic gradient descent, batch gradient descent, gradient boost, meta-heuristics, and the like.

The visual-language model 108 may be a machine learning model that may be trained to generate object-centric representations based on object prompts. The visual-language model 108 may be queried using an object prompt that may be indicative of a domain that includes a set of objects. The set of objects may be required to be detected in frames of video segments included in the first sequence of video segments 116. In some embodiments, the object prompt that may be indicative of the set of objects that are required to be detected. The visual-language model 108 may receive video segments of the first sequence of video segments 116 and an object prompt as inputs. Each video segment of the first sequence of video segments 116 may include a set of video frames. The visual-language model 108 may associate, contrastively, different regions of each video frame of each video segment with text descriptions. The regions of each video frame may be annotated with bounding boxes based on detection of objects that belong to the domain at the regions of each video frame. The text descriptions associated with the regions may constitute textual representations of the detected objects which may also be included in the object prompt. The detected objects may be further mapped to actions (i.e., verbs) that may be performed by use of the detected objects. Based on the association of the regions of the frames of the video segments with text descriptions and the mapping of the detected objects with actions, generic object-centric representations may be obtained as outputs of the visual-language model 108.

The PTE model 110 may be a machine learning model that may be trained to generate the set of object-action pairs 120. The generation of the set of object-action pairs 120 may be based on the object-centric representations generated by the visual-language model 108. Each object-action pair of the set of object-action pairs 120 may be associated with a video segment of the second sequence of video segments 118. The actions included in object-action pairs of the set of object-action pairs 120 may be predicted based on inclusion of objects (that belongs to the domain) in the video segments of the second sequence of video segments 118. The predicted actions are actions that are likely to be performed using objects included in the object-action pairs of the set of object-action pairs 120.

In accordance with an embodiment, the PTE model 110 may be an aggregator network that may receive inputs from object and video encoders and provide outputs to a transformer decoder for prediction of a set of actions. The transformer encoder may receive the object-centric representations and the first sequence of video segments 116 as inputs and generate multimodal (i.e., video and object) representations as outputs. The multimodal representations may constitute embeddings associated with each video segment of the first sequence of video segments 116 and each object (belonging to the domain) detected in a video segment of the first sequence of video segments 116. The aggregator network (i.e., the PTE model 110) may fuse the multimodal representations across space and time to generate a set of aggregated features. The set of aggregated features may be generated further based on timing information associated with each video segment of the second sequence of video segments 118. The transformer decoder may receive the set of aggregated features as inputs and generate the set of actions as a predicted output. Each action of the set of predicted actions may be associated with a video segment of the second sequence of video segments 118 and an object belonging to the domain. Based on the set of predicted actions and associated objects, object-action pairs of the set of object-action pairs 120 may be generated as the predicted output.

In accordance with an embodiment, each of the visual-language model 108 and the PTE model 110 may include electronic data that may be implemented as a software component of an application executable on the electronic device 102. Each of the visual-language model 108 and the PTE model 110 may rely on one or more of libraries, logic/instructions, or external scripts, for execution by a processing device included in the electronic device 102. In one or more embodiments, each of the visual-language model 108 and the PTE model 110 may be implemented using hardware that may include a processor, a microprocessor (for example, to perform or control performance of one or more operations), a Field-Programmable Gate Array (FPGA), or an application-specific integrated circuit (ASIC). Alternatively, in some embodiments, each of the visual-language model 108 and the PTE model 110 may be implemented using a combination of hardware and software. Examples of the visual-language model 108 and the PTE model 110 may include, but are not limited to, a deep neural network (DNN), a convolutional neural network (CNN), a recurrent neural network (RNN), a CNN-RNN, R-CNN, Fast R-CNN, Faster R-CNN, Contrastive Language-Image Pre-Training (CLIP) network, Grounded Language-Image Pre-training (GLIP) network, an artificial neural network (ANN), (You Only Look Once) YOLO network, a Long Short Term Memory (LSTM) network based RNN, an attention based neural network, a transformer neural network, CNN+ANN, LSTM+ANN, a gated recurrent unit (GRU)-based RNN, a fully connected neural network, a Connectionist Temporal Classification (CTC) based RNN, a deep Bayesian neural network, a Generative Adversarial Network (GAN), and/or a combination of such networks. In some embodiments, the visual-language model 108 and/or the PTE model 110 may be based on a hybrid architecture of multiple DNNs.

The database 112 may include suitable logic, interfaces, and/or code that may be configured to store the video content 114. The database 112 may receive a query from the electronic device 102 or the server 104 for the video content 114. Based on the received query, the database 112 may generate a query response that may include the video content 114. The database 112 may be derived from data off a relational or non-relational database or a set of comma-separated values (csv) files in conventional or big-data storage. The database 112 may be stored or cached on a device, such as the electronic device 102 or the server 104. In an embodiment, the database 112 may be hosted on a plurality of servers stored at same or different locations. The operations of the database 112 may be executed using hardware that may include a processor, a FPGA, an ASIC, or a microprocessor (for example, to perform or control performance of one or more operations). In some other instances, the database 112 may be implemented using software.

In operation, the electronic device 102 may extract the first sequence of video segments 116 from the video content 114. The video content 114 may be associated with a domain. For example, the video content 114 may be associated with a kitchen domain. The video content 114 may depict items (i.e., objects) that may be included in a kitchen. The video content 114 may further depict a human or an intelligent agent (such as, a robot) who may be performing activities by use of the objects in the kitchen. The video content 114 may be split into a plurality of segments, and the first sequence of video segments 116 may be extracted from the plurality of segments of the video content 114. Each segment of the first sequence of video segments 116 may include objects (for example, objects situated in a kitchen) which may be required to be detected.

The electronic device 102 may further detect a set of objects in the first sequence of video segments 116. The detection of the set of objects may be a part of a process of generation of object-centric representations associated with the first sequence of video segments 116. In accordance with an embodiment, the electronic device 102 may query the visual-language model 108 by use of an object prompt for the generation of object-centric representations as an output of the visual-language model 108. The electronic device 102 may receive the object prompt as a user input. The user input may be indicative of the domain (i.e., kitchen) or a list of objects associated with the domain (i.e., objects that are likely to be detected in a kitchen setting). Based on the type of information (i.e., domain name or names of objects) included in the queried object prompt, the electronic device 102 may determine a set of domain objects that may be likely to be detected in the first sequence of video segments 116.

On determination of the set of domain objects, the electronic device 102 may apply the visual-language model 108 on the first sequence of video segments 116. Based on the application, the set of objects may be detected in the first sequence of video segments 116. The set of objects may include domain objects of the set of domain objects. A count of objects included in the set of detected objects may be based on a count of video segments included in the first sequence of video segments 116, a count of video frames included in each video segment of the first sequence of video segments 116, and a confidence score associated with detection of an object in a video frame of a video segment. The visual-language model 108 may further map each detected object of the set of objects with an action for the generation of the object-centric representations. The mapping may indicate that the mapped action may be performed (for example, in the kitchen) by use of the corresponding detected object of the set of objects. The object-centric representations may enable anticipation of future actions.

The electronic device 102 may further generate a set of embeddings based on the extracted first sequence of video segments 116 and the detected set of objects. The set of embeddings may be multimodal representations associated with video segments and objects. In accordance with an embodiment, the set of embeddings may include an embedding associated with each video segment of the first sequence of video segments 116 and an embedding associated with each object of the set of objects. In accordance with an embodiment, embeddings associated with video segments of the first sequence of video segments 116 may be generated based on an application of a video encoder on video segment representations (i.e., video segment-related information derived from frames within the segment, such as the actions or movements of the human actor). Similarly, the embeddings associated with objects of the set of objects, which may be detected in video segments of the first sequence of video segments 116, may be generated based on an application of an object encoder on the object-centric representations (i.e., object-related information in the object-centric representations).

Each embedding of the set of embeddings associated with a video segment of the first sequence of video segments 116 may be generated based on information such as time-instances of starting and ending of the video segment, objects that may be included in the video segment, and actions mapped to the objects. On the other hand, each embedding of the set of embeddings associated with an object of the set of objects, which may be detected in a video segment of the first sequence of video segments 116, may be generated based on information such as coordinates of a region of a video frame of the video segment where the object is detected. The generated embeddings of the set of embeddings associated with each of the video segments of the first sequence of video segments 116 may be combined for generation of a video segment-based representation. Similarly, the generated embeddings of the set of embeddings associated with each of the objects of the set of objects may be combined for generation of an object-based representation. The multimodal representations may be constituted of the video segment-based representation and the object-based representation.

The electronic device 102 may further apply the predictive transformer encoder (PTE) model 110 on the set of embeddings. The PTE model 110 may be applied on the generated set of embeddings for fusion of the multimodal representations across space and time. The PTE model 110 may function as an aggregator network that may aggregate or fuse the video segment-based representation and the object-based representation (i.e., the multimodal representations) across space (content within a video segment) and time (content across multiple video segments). The fusion may enable determination of features, based on which future actions, that may be performed using objects of the set of objects, may be anticipated. The electronic device 102 may further apply the PTE model 110 on the second sequence of video segments 118. The second sequence of video segments 118 may be extracted from the plurality of segments of the video content 114. The future actions (to be anticipated) and the objects, using which the future actions may be performed, may be associated with the second sequence of video segments 118.

The electronic device 102 may further predict, based on the application of the PTE model 110, the set of object-action pairs 120 associated with the second sequence of video segments 118 of the video content 114. The second sequence of video segments 118 may succeed the first sequence of video segments 116 in a playback timeline of the video content 114. Each object-action pair (such as the first object-action pair 120A) of the predicted set of object-action pairs 120 may include an action that is likely to be executed and an object using which the action is likely to be executed. Further, each object in a predicted object-action pair may be included in a video segment of the second sequence of video segments 118. For example, a first video segment of the second sequence of video segments 118 may depict performance of a predicted action using an object. The predicted action and the object may constitute the object-action pair 120A. The object constituting the object-action pair 120A may be included in the set of objects detected in the first sequence of video segments 116.

In accordance with an embodiment, the PTE model 110 may generate a set of aggregated features based on the multimodal representations (i.e., the set of generated embeddings indicative of the video segment-based representation and the object-based representation). The set of aggregated features may be generated further based on timing and positional information associated with each video segment of the second sequence of video segments 118 relative to other video segments of the second sequence of video segments 118. Thus, each video segment may be associated with an aggregated feature of the set of aggregated features. Based on an application of a decoder on the set of aggregated features, the decoder may predict the set of object-action pairs 120. Thus, each object-action pair of the set of object-action pairs 120 may correspond to an aggregated feature of the set of aggregated features generated by the PTE model 110. The electronic device 102 may further render information associated with the predicted set of object-action pairs 120 and the second sequence of video segments 118. The rendered information may include a mapping between objects and actions in each object-action pair of the set of object-action pairs 120. The rendered information may include an associations between object-action pairs of the set of object-action pairs 120 and video segments of the second sequence of video segments 118. The associations may indicate future depictions of execution of actions using objects in video segments of the second sequence of video segments 118. The actions and objects may belong to the object-action pairs of the set of object-action pairs 120.

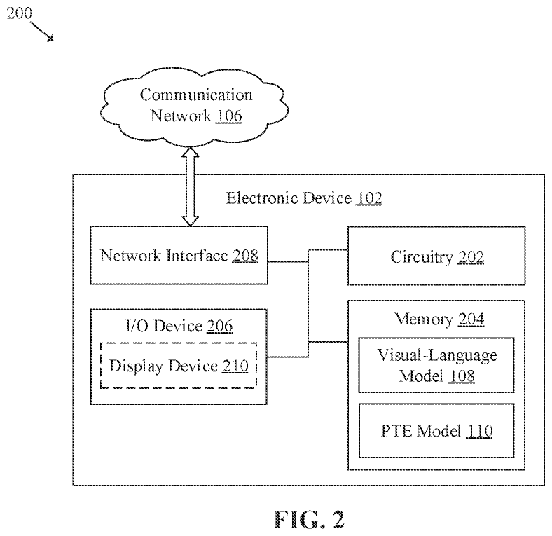

FIG. 2 is a block diagram that illustrates an exemplary electronic device that generates an object-centric video representation for action prediction, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, a I/O device 206, and a network interface 208. In at least one embodiment, the memory 204 may include the visual-language model 108 and the PTE model 110. In at least one embodiment, the I/O device 206 may include a display device 210. The circuitry 202 may be communicatively coupled to the memory 204, the I/O device 206, and the network interface 208, via wired or wireless communication of the electronic device 102.

The circuitry 202 may include suitable logic, circuitry, and/or interfaces that may be configured to execute program instructions associated with different operations to be executed by the electronic device 102. The operations may include extraction of a first sequence of video segments 116, detection of a set of objects in the first sequence of video segments 116, generation of a set of embeddings, application of the PTE model 110, prediction of the set of object-action pairs 120, and rendering of information associated with the predicted set of object-action pairs 120 and the second sequence of video segments 118. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an ASIC, a FPGA, or any other digital or analog circuitry configured to interpret and/or to execute program instructions and/or to process data. The circuitry 202 may include any number of processors configured to, individually or collectively, perform or direct performance of any number of operations of the electronic device 102, as described in the present disclosure. Examples of the circuitry 202 may include a Central Processing Unit (CPU), a Graphical Processing Unit (GPU), a Tensor Processing Unit (TPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the program instructions to be executed by the circuitry 202. The program instructions stored on the memory 204 may enable the circuitry 202 to execute operations of the circuitry 202 (of the electronic device 102). In an embodiment, the memory 204 may be configured to store the video content 114, the first sequence of video segments 116, and the second sequence of video segments 118. The memory 204 may be further configured to store the generated set of embeddings associated with video segments of the first sequence of video segments 116 and objects of the detected set of objects. The memory 204 may be further configured to store the set of object-action pairs 120. The memory 204 may be further configured to store the information associated with the predicted set of object-action pairs 120 and the second sequence of video segments 118. Examples of implementation of the memory 204 may include, but are not limited to, Random Access Memory (RAM), Read Only Memory (ROM), Hard Disk Drive (HDD), Electrically Erasable Programmable Read-Only Memory (EEPROM), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a user input indicative of an instruction to acquire the video content 114. The I/O device 206 may further receive a user input indicative of an object prompt to be used for querying the visual-language model 108 for detection of the set of objects. The I/O device 206 may further receive a user input to indicate a time-instance that corresponds to an ending of a last video segment of the first sequence of video segments 116 and a starting of a first video segment of the second sequence of video segments 118. The I/O device 206 may render information associated with the predicted set of object-action pairs 120 and the second sequence of video segments 118. Examples of the I/O device 206 may include, but are not limited to, a touch screen, a keyboard, a mouse, a joystick, a microphone, the display device 210, and a speaker.

The I/O device 206 may include the display device 210. The display device 210 may include suitable logic, circuitry, and interfaces that may be configured to receive inputs from the circuitry 202 to render, on a display screen, the detected set of objects, the set of object-action pairs 120, and the information associated with the predicted set of object-action pairs 120 and the second sequence of video segments 118. In at least one embodiment, the display screen of the display device 210 may be at least one of a resistive touch screen, a capacitive touch screen, or a thermal touch screen. The display device 210 or the display screen may be realized through several known technologies such as, but not limited to, at least one of a Liquid Crystal Display (LCD) display, a Light Emitting Diode (LED) display, a plasma display, or an Organic LED (OLED) display technology, or other display devices.

The network interface 208 may include suitable logic, circuitry, and interfaces that may be configured to facilitate a communication between the circuitry 202 and the server 104, via the communication network 106. The network interface 208 may be implemented by use of known technologies to support wired or wireless communication of the electronic device 102 with the communication network 106. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate wirelessly with networks via the Internet, an Intranet, or a wireless network, such as a cellular telephone network, a satellite communication network, a wireless local area network (LAN), a short-range communication network, and a metropolitan area network (MAN). The wireless communication may use communication standards, protocols and technologies, such as Global System for Mobile Communications (GSM), Enhanced Data GSM Environment (EDGE), wideband code division multiple access (W-CDMA), Long Term Evolution (LTE), New Radio (NR), code division multiple access (CDMA), time division multiple access (TDMA), Bluetooth, Wi-Fi (such as IEEE 802.11a, IEEE 802.11b, IEEE 802.11g or IEEE 802.11n), light fidelity (Li-Fi), Worldwide Interoperability for Microwave Access (Wi-MAX), voice over internet protocol, a near field communication protocol, and a wireless peer-to-peer protocol.

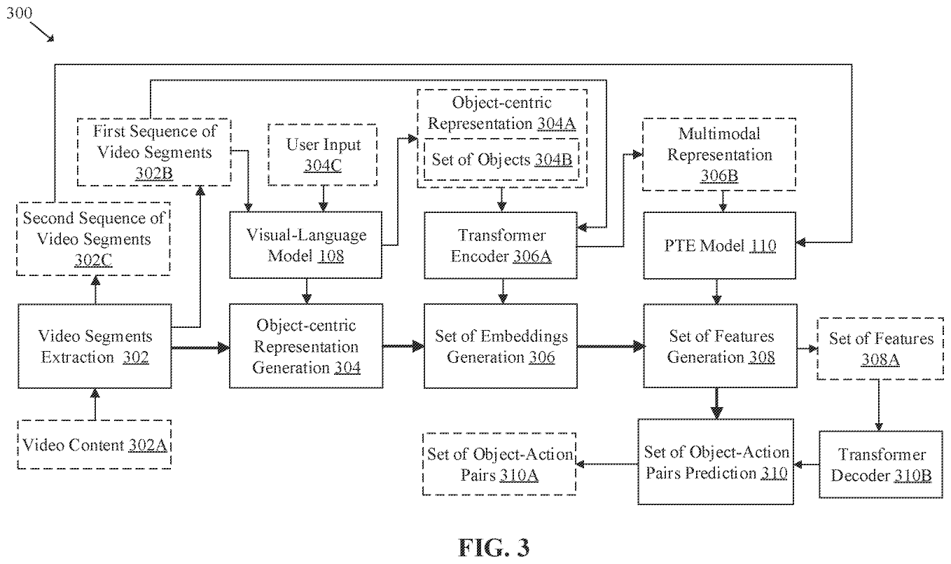

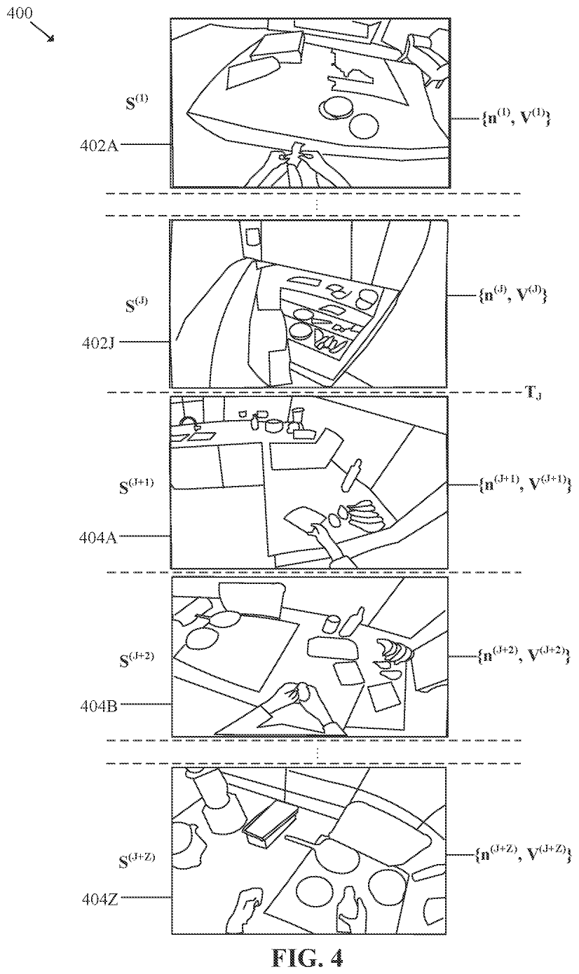

The functions of the electronic device 102 or operations executed by the electronic device 102, as described in FIG. 1, may be performed by the circuitry 202. Operations executed by the circuitry 202 are described in detail, for example, in the FIG. 3 and FIG. 4.

FIG. 3 is a diagram that illustrates an exemplary execution pipeline for generation of an object-centric video representation for action prediction, in accordance with an embodiment of the disclosure. FIG. 3 is explained in conjunction with elements from FIG. 1 and FIG. 2. With reference to FIG. 3 there is shown an exemplary processing pipeline 300 that illustrates exemplary operations from 302 to 310 for generation of an object-centric video representation for action prediction. The exemplary operations 302 to 310 may be executed by any computing system, for example, by the electronic device 102 of FIG. 1 or by the circuitry 202 of FIG. 2.

At 302, a plurality of video segments may be extracted from video content 302A. In at least one embodiment, the circuitry 202 may be configured to extract the plurality of video segments from the video content 302A. The video content 302A may be associated with a domain. For example, the domain may be a kitchen domain. The video content 302A may depict execution of a physical task in the kitchen. The execution of the physical task may involve execution of a set of actions by use of objects situated in the kitchen. The extracted plurality of video segments may include a first sequence of video segments 302B and a second sequence of video segments 302C. For example, a count of video segments included in the plurality of video segments, extracted from the video content 302A, may be 30. The count may be summation of a count of video segments in the first sequence of video segments 302B (which may be represented as N_{V}) and a count of video segments in the second sequence of video segments 302C (which may be represented as Z). The first sequence of video segments 302B may include 10 video segments and the second sequence of video segments 302C may include 20 video segments. The lengths of each of the plurality of video segments, extracted from the video content 302A, may vary (such as, 3, 5, or 8 seconds) and may correspond to a specific action, such as “crack egg”.

The plurality of video segments may span a time interval. The circuitry 202 may be configured to receive a user input that may be indicative of the time interval. The time interval may include the first sequence of video segments 302B and the second sequence of video segments 302C. The second sequence of video segments 302C may succeed the first sequence of video segments in a playback timeline (i.e., the time interval) of the video content 302A. In an embodiment, the circuitry 202 may be configured to receive a user input indicative of a time-instance included in the playback timeline. The extraction of the first sequence of video segments 302B and the second sequence of video segments 302C may be such that the first sequence of video segments 302B may terminate at the time-instance and the second sequence of video segments 302C may start at the time-instance. The first sequence of video segments 302B may represent the observed video segments, based on which future actions associated with each video segment of the second sequence of video segments 302C may be predicted.

At 304, an object-centric representation 304A may be generated based on a detection of a set of objects 304B in the first sequence of video segments 302B. In at least one embodiment, the circuitry 202 may be configured to generate the object-centric representation 304A based on detection of the set of objects 304B in the first sequence of video segments 302B. The circuitry 202 may apply the visual-language model 108 on each video segment of the first sequence of video segments 302B and on information associated with the set of objects 304B that is to be detected in the first sequence of video segments 302B. The information may be included in a user input 304C. The set of objects 304B may be detected based on application of the visual-language model 108 on the user input 304C and the first sequence of video segments 302B.

In accordance with an embodiment, the circuitry 202 may be configured receive the user input 304C that may be indicative of the domain (for example, the kitchen). The user input 304C may be an object prompt that may be queried to the visual-language model 108. Based on the domain indicated in the received user input (i.e., the queried object prompt), a set of domain objects may be determined. For example, the set of domain objects may include items (such as stove, grinder, pan, bowl, and so on) that may be likely to be detected in a kitchen. Therefore, the set of objects 304B, which may be detected in the first sequence of video segments 302B of the video content 302A, may include domain objects of the determined set of domain objects.

In some embodiments, the circuitry 202 may receive a user input indicative of the set of domain objects. The set of domain objects indicated in the received user input may be based on the domain. In such embodiments, the queried object prompt may include the set of domain objects from which the set of objects 304B may be detected.

Each video segment of the first sequence of video segments 302B may include a predefined number of video frames (which may be represented as N_{IMG}). If the number of video frames included in each video segment is different, N_{IMG} video frames may be subsampled from each video segment. Further, a subset of objects of the set of objects 304B may be detected in each video frame of each video segment (i.e., the predefined number of video frames). Each object of the subset of objects may be detected with a certain degree of confidence that may be greater than a threshold confidence. A count of objects (which may be represented as N_{O}) included in the set of objects 304B, detected in the first sequence of video segments 302B, may be a product of a count of objects included in the subset of objects (which may be represented as N_{OBJ}), N_{IMG} (i.e., the predefined number of video frames), and N_{V} (i.e., the count of video segments included in the first sequence of video segments 302B).

Each detected object of the set of objects 304B may be mapped to an action for generation of an action label. The mapping may be based on execution of the action by use of the corresponding detected object of the set of objects 304B. The action label may be represented as an object-action pair that may include the corresponding detected object and the mapped action. The object-centric representation 304A may, thus, include information associated with each video segment of the first sequence of video segments 302B and each detected object of the set of objects 304B. The information may include starting and ending time-instances associated with each video segment of the first sequence of video segments 302B, and coordinates of each object of the set of objects 304B that may be detected in a video frame of a video segment of the first sequence of video segments 302B. The information may include mappings between the detected objects of the set of objects 304B and actions that may be executed by use of the detected objects, and association of each video segment of the first sequence of video segments 116 with such object-action pairs. Herein, an object-action pair may include an object of the set of objects 304B detected in a video segment and an action executed using the detected object.

At 306, a set of embeddings may be generated based on the first sequence of video segments 302B and the object-centric representation 304A. In at least one embodiment, the circuitry 202 may be configured to generate the set of embeddings based on the first sequence of video segments 302B and the object-centric representation 304A. The set of embeddings may include a first subset of embeddings that may be associated with the first sequence of video segments 302B and a second subset of embeddings that may be associated with the set of objects 304B. The circuitry 202 may apply a transformer encoder 306A on each video segment of the first sequence of video segments 302B where an object of the set of objects 304B may be detected (for the generation of the object-centric representation 304A). The transformer encoder 306A may include a video encoder and an object encoder. The circuitry 202 may generate a multimodal representation 306B based on the first sequence of video segments 302B and the set of objects 304B. The multimodal representation 306B may correspond to the set of embeddings as the multimodal representation 306B may represent a combination of a video segment-based representation (which may be obtained based on the first subset of embeddings) and an object-based representation (which may be obtained based on the second subset of embeddings).

The video segment-based representation (which may be represented as E_{CLIP}) may be generated based on embeddings associated with video segments of the first sequence of video segments 302B. In accordance with an embodiment, the circuitry 202 may apply the video encoder on each video segment of the first sequence of video segments 302B. Based on the application, the first subset of embeddings may be generated. The first subset of embeddings may include an embedding associated with each video segment of the first sequence of video segments 302B. The size of the embedding associated with each video segment may be “D”. The embedding associated with each video segment may be generated based on an object of the set of objects 304B that may be detected in a video frame of the corresponding video segment, an action executed by use of the detected object (i.e., the object-action pair), a first time-instance associated with a start of the corresponding video segment, or a second time-instance associated with an end of the corresponding video segment. The circuitry 202 may concatenate the embeddings of the first subset of embeddings for the generation of the video segment-based representation. As the first sequence of video segments 302B may include “N_{V}” video segments, “E_{CLIP}” may include “N_{V}×D” elements.

The object-based representation (which may be represented as E_{OBJ}) may be generated based on embeddings associated with objects of the set of objects 304B. In accordance with an embodiment, the circuitry 202 may apply the object encoder on each video segment of the first sequence of video segments 302B. Based on the application, the second subset of embeddings may be generated. The second subset of embeddings may include an embedding associated with each object of the set of objects 304B. The size of the embedding associated with each object of the set of objects 304B may be “D”. Each embedding of the second subset of embeddings, associated with an object of the set of objects 304B, may be generated based on coordinates of a bounding box that may include the object. The coordinates may be associated with a video frame of a video segment of the first sequence of video segments 302B, where the object may be detected. The circuitry 202 may concatenate the embeddings of the second subset of embeddings for the generation of the object-based representation. As the set of objects 304B includes “N_{O}” objects, “E_{OBJ}” may include “N_{O}×D” elements. Thus, the multimodal representation 306B may represent a combination of “E_{CLIP}” and “E_{OBJ}”.

At 308, a set of features 308A may be generated based on the multimodal representation 306B. In at least one embodiment, the circuitry 202 may be configured to generate the set of features 308A based on the multimodal representation 306B. The generation may be based on an application of the PTE model 110 on the generated set of embeddings (based on which the multimodal representation 306B may be generated). The set of features 308A may be generated for prediction of a set of future actions that may be executed by use of objects of the set of objects 304B. Each feature of the set of features 308A may be associated with a video segment of the second sequence of video segments 302C. Thus, each video segment of the second sequence of video segments 302C may be associated with a predicted action that may be executed using an object. The set of features 308A may include “Z” features, as the count of video segments that are included in the second sequence of video segments 302C is “Z”. The corresponding video segment may depict execution of the predicted action using an object of the set of objects 304B. The object and the predicted action may be included in a predicted object-action pair, which may be associated with the corresponding video segment.

The set of features 308A may be generated based on an aggregation of the multimodal representation 306B across space and time. The set of features 308A may be generated further based on a positional and modality-based representation (which may be represented as E_{POS}) associated with the second sequence of video segments 302C. In accordance with an embodiment, the circuitry 202 may generate a third subset of embeddings based on timestamp information associated with each video segment of the second sequence of video segments 302C. The size of each embedding of the third subset of embeddings, associated with each video segment of the second sequence of video segments 302C, may be “D”. The circuitry 202 may concatenate the embeddings of the third subset of embeddings for the generation of the positional representation. As, the count of video segments included in the second sequence of video segments 302C includes “Z” video segments, “E_{POS}” may include “Z×D” elements.

In accordance with an embodiment, the circuitry 202 may apply the PTE model 110 on each of the first subset of embeddings associated with the first sequence of video segments 302B, the second subset of embeddings associated with the set of objects 304B, and the third subset of embeddings associated with the second sequence of video segments 302C. The application of the PTE model 110 may result in a fusion of the video segment-based representation (E_{CLIP}), the object-based representation (E_{OBJ}), and the positional representation (E_{POS}). The fusion may result in inclusion of positional encodings (i.e., the third set of embeddings) to a sequence that may be representing the aggregation of the multimodal representation 306B across space and time. Based on the fusion of “E_{CLIP}”, “E_{OBJ}”, and “E_{POS}” (i.e., the application of the PTE model 110), an encoded sequence may be generated. The encoded sequence may be a concatenation of “E_{CLIP}”, “E_{OBJ}”, and “E_{POS}”. The circuitry 202 may apply the PTE model 110 on the encoded sequence for the generation of the set of features 308A. Thus, the generation of the set of features 308A, associated with the second sequence of video segments 302C, may be based on the encoded sequence.

At 310, a set of object-action pairs 310A may be predicted based on the set of features 308A. In at least one embodiment, the circuitry 202 may be configured to predict the set of object-action pairs 310A based on the set of features 308A. The set of object-action pairs 310A may be predicted based on application of a transformer decoder 310B on the generated set of features 308A. The set of object-action pairs 310A may include “Z” object-action pairs and each of the “Z” object-action pairs may be associated with a video segment of the “Z” video segments included in the second sequence of video segments 302C. For each input feature of the set of features 308A, the transformer decoder 310B may predict an action. The predicted action may be executed using an object of the set of objects 304B. The predicted action and the object may constitute an object-action pair of the set of object-action pairs 310A.

For example, the transformer decoder 310B may receive a first feature of the set of features 308A as input and generate a first object-action pair of the set of object-action pairs 310A as output. The first feature and the first object-action pair may be associated with a first video segment of the second sequence of video segments 302C. The first video segment of the second sequence of video segments 302C is likely to depict the execution of the predicted action using the first object. Similarly, other object-action pairs of the set of object-action pairs 310A may be generated as outputs of the transformer decoder 310B based on predictions of actions associated with other video segments of the second sequence of video segments 302C.

In accordance with an embodiment, the circuitry 202 may determine, for each feature of the generated set of features 308A, a set of candidate object-action pairs. For example, the transformer decoder 310B may generate “K” candidate object-action pairs as outputs based on an input N^{th} feature of the set of features 308A. The N^{th} feature may be associated with a N^{th} video segment of the second sequence of video segments 302C. The generation of the “K” candidate object-action pairs may be based on a prediction of “K” candidate actions that are likely to be executed using “K” objects. The circuitry 202 may further determine a confidence score associated with each candidate object-action pair of the determined set of candidate object-action pairs. Thus, “K” confidence scores associated with the “K” candidate object-action pairs may be determined. The circuitry 202 may select a candidate object-action pair from amongst the “K” candidate object-action pairs included in the set of candidate object-action pairs. The confidence score associated with the selected candidate object-action pair may be the highest, compared to confidence scores associated with other candidate object-action pairs of the set of candidate object-action pairs. The action included in the selected object-action pair may be the action (out of the “K” candidate actions) that is predicted as likely to be executed using an object (out of the “K” objects) and execution of the predicted action is likely to be depicted in the N^{th} video segment. The selected candidate object-action pair may be a predicted object-action pair of the set of object-action pairs 310A.

In accordance with an embodiment, the circuitry 202 may render, on the display device 210, information associated with the predicted set of object-action pairs and the second sequence of video segments 302C. Further, the circuitry 202 may train an action prediction model based on the predicted set of object-action pairs 310A and on the second sequence of video segments 302C. The trained action prediction model may be configured to predict human-object interactions or an intelligent agent-object interactions from input video frames (i.e., observable video frames such as the first sequence of video segments 302B) associated with the domain (such as, the kitchen domain).

Typically, an action anticipation task may involve generation of a sequence of actions that are likely to be performed, by a human or an intelligent agent, using objects that may be detected in frames of a video. The generation of the sequence of actions may be dependent on leveraging of an object detector that is trained on in-domain bounding box annotation. The objects may be associated with a specific domain and specific actions may be performed using the set of objects. Thus, the frames of the video may be annotated with bounding boxes around one or more objects, that may be detected in the frames of the video. The detection of one or more objects may allow recognition or prediction of future human-object or intelligent agent (for example, a robot)-object interactions. However, the in-domain bounding box annotation can be expensive and susceptible to annotation errors and biases, especially in large datasets or frames depicting heavily populated scenes. Therefore, scaling an object-based video recognition framework to in-domain bounding box annotation on visually diverse frames, or frames that render complex or cluttered scenes, may be infeasible or challenging.

The issues associated with object-based video recognition frameworks may be avoided by relying on an attention mechanism. An attention network that actualizes the attention mechanism may be applied directly on patches of the frames of the video for determination of salient regions in the frames with a weak supervision on action labels. The salient regions may include objects of interest. Although, flexibility of the attention network may be greater compared to the object-based video recognition framework, the attention network may not incorporate information associated with locations of objects of interest that are to be detected in the frames of the video. As such, the determined salient regions may not include any object of interest or include objects that are not the objects of interest, especially when training data used to train the attention network is limited.

To address the above-mentioned issues, the disclosed electronic device 102 may be configured to leverage a pretrained visual-language model (e.g., the visual-language model 108) for detection of objects, which may be associated with a specific domain (e.g., a kitchen domain), in a first sequence of video segments (e.g., the first sequence of video segments 302B). For such detection, the pretrained visual-language model (e.g., the visual-language model 108) may be queried using an object prompt. The set of objects, that are to be detected, may be included in the object prompt. Based on the queried object prompt, an object-centric representation may be generated as output of the pretrained visual-language model (e.g., the visual-language model 108) for action anticipation. The generation of the output may be based on mapping of each detected object (which may be included in the object prompt) to an action that may be performed by use of the corresponding detected object. The electronic device 102 may further use a transformer encoder network (e.g., the transformer encoder 306A) to predict (or anticipate) a set of future actions, which may be performed using objects included in a second sequence of video segments (e.g., the second sequence of video segments 302C). The prediction of the set of future actions may be based on multimodal embeddings associated with the first sequence of video segments, the set of objects that are detected in the first sequence of video segments, and timing information associated with the second sequence of video segments. The set of future actions may be predicted or anticipated for execution of a long-term anticipation (LTA) task or execution of a next-action prediction (NAP) task.

FIG. 4 is an exemplary scenario diagram that illustrates prediction of a set of object-action pairs associated with a second sequence of video segments based on a set of object-action labels associated with a first second sequence of video segments, in accordance with an embodiment of the disclosure. FIG. 4 is explained in conjunction with elements from FIG. 1, FIG. 2, and FIG. 3. With reference to FIG. 4, there is shown an exemplary scenario 400. In the exemplary scenario 400, there is shown a plurality of video segments that may be extracted from video content associated with a kitchen domain. The plurality of video segments may include a first sequence of video segments 402A-402J and a second sequence of video segments 404A-404Z. The second sequence of video segments 404A-404Z may succeed the first sequence of video segments 402A-402J in a playback timeline of the video content. The circuitry 202 may receive a user input that may indicate a time-instance, based on which the first sequence of video segments 402A-402J and the second sequence of video segments 404A-404Z may be extracted. For example, the time-instance may be “T_{J}” in the playback timeline of the video content. The video segments in the playback timeline of the video content prior to “T_{J}” may constitute the first sequence of video segments 402A-402J, whereas the video segments in the playback timeline of the video content after “T_{J}” may constitute the second sequence of video segments 404A-404Z.

The first sequence of video segments 402A-402J may include “J” observed video segments. Each video segment of the first sequence of video segments 402A-402J may depict a person performing an action by use of an object of a set of objects. The set of objects may be detected in the first sequence of video segments 402A-402J. For example, the video segment 402A may depict the person tying a rope and the J^{th} video segment 402J may depict the person opening a fridge. The second sequence of video segments 404A-404Z may include “Z” video segments. Based on object-centric representations, which may be built based on the observed video segments, future actions associated with succeeding video frames may be predicted. For example, the circuitry 202 may be configured to predict “Z” future actions. The second sequence of video segments 404A-404Z may depict execution of the “Z” future actions. The circuitry 202 may predict that the video segment 404A may depict the person keeping an object on a table in the kitchen, the video segment 404B may depict the person peeling some fruit, and the video segment 404Z may depict the person pouring water. The “Z” future actions may be executed using “Z” objects that may be detected in the first sequence of video segments 402A-402J. The detected objects may be represented as “n” (i.e., nouns) and the actions executed by use of the objects may be represented as “V” (i.e., verbs). Thus, each object-action pair associated with a video segment may be represented as a noun-verb pair (n^{(J)}, V^{(J)}), where “J” represents an index of the video segment.

The circuitry 202 may detect a set of objects in the first sequence of video segments 402A-402J based on application of the visual-language model 108 on video segments of the first sequence of video segments 402A-402J. In each video segment of the first sequence of video segments 402A-402J, an object of the set of objects may be detected. The object may be mapped to an action that may be executed using the object. For example, an object “n⁽¹⁾” may be detected in a video frame included in a first video segment (i.e., S⁽¹⁾) 402A of the first sequence of video segments 402A-402J. The object “n⁽¹⁾” may be mapped to an action “V⁽¹⁾” Similarly, an object “n^{(J)}” may be detected in a video frame included in a “J^{th}” video segment (i.e., S^{(J)}) 402J of the first sequence of video segments 402A-402J. The object “n^{(J)}” may be mapped to an action “V^{(J)}”. The detected set of objects, coordinates of bounding boxes annotated in video frames where objects of the set of objects may be detected, and mapping of actions with objects of the set of objects may constitute an object-centric representation. Based on the first sequence of video segments 402A-402J, the set of objects detected in the first sequence of video segments 402A-402J, and the object-centric representation, a set of embeddings may be generated. The set of embeddings may include embeddings associated with each video segment of the first sequence of video segments 402A-402J, embeddings associated with the set of objects, and embeddings associated with each video segment of the second sequence of video segments 404A-404Z.

Thereafter, the circuitry 202 may apply the PTE model 110 on the generated set of embeddings to predict a set of object-action pairs. The set of object-action pairs may be associated with the second sequence of video segments 404A-404Z of the video content. The predicted set of object-action pairs may include “Z” object-action pairs, i.e., {n^{(J+1)}, V^{(J+1)}}, . . . , and {n^{(J+Z)}, V^{(J+Z)}}. The predicted object-action pair {n^{(J+1)}, V^{(J+1)}} may be associated with the first video segment (i.e., S^{(J+1)}) 404A of the second sequence of video segments 404A-404Z. Similarly, the predicted object-action pair {n^{(J+Z)}, V^{(J+Z)}} may be associated with the “Z^{th}” video segment (i.e., S^{(J+1)}) 404Z of the second sequence of video segments 404A-404Z.

The set of object-action pairs may be predicted based on anticipation of “Z” future actions associated with “Z” video frames included in the second sequence of video segments 404A-404Z. The objects included in the “Z” object-action pairs, i.e., the nouns n^{(J+1)}, . . . , and n^{(J+2)}, may be objects of the set of objects detected in the first sequence of video segments 402A-402J. The predicted future actions included in the “Z” object-action pairs, i.e., the verbs V^{(J+1)}, . . . , and V^{(J+2)}, which may be executed by the objects, i.e., the nouns n^{(J+1)}, . . . , and n^{(J+2)}. The execution of each of the predicted actions may be depicted in video segments of the second sequence of video segments 404A-404Z.

It should be noted that the scenario 400 of FIG. 4 is for exemplary purposes and should not be construed to limit the scope of the disclosure.

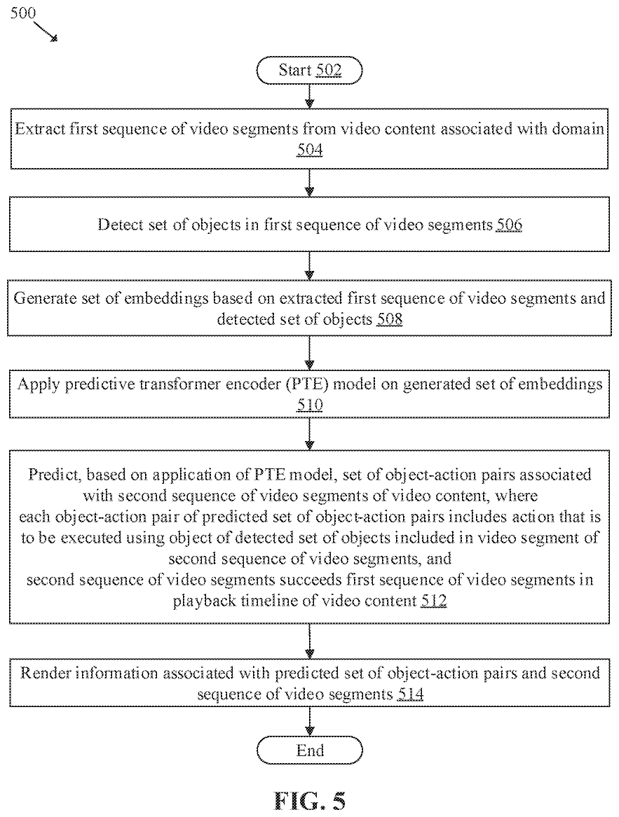

FIG. 5 is a flowchart that illustrates exemplary operations for generation of an object-centric video representation for future action prediction, in accordance with an embodiment of the disclosure. With reference to FIG. 5, there is shown a flowchart 500. The flowchart 500 is described in conjunction with elements from FIG. 1, FIG. 2, FIG. 3, and FIG. 4. The operations from 502 to 514 may be implemented, for example, by the electronic device 102 of FIG. 1 or the circuitry 202 of FIG. 2. The operations of the flowchart 500 may start at 502 and proceed to 504.

At 504, a first sequence of video segments (such as, the first sequence of video segments 116) may be extracted from video content (such as the video content 114) associated with a domain. In at least one embodiment, the circuitry 202 may be configured to extract the first sequence of video segments 116 from the video content 114 associated with the domain. Details about the extraction of the first sequence of video segments 116 are described, for example, in FIG. 1 and FIG. 3.

At 506, a set of objects may be detected in the first sequence of video segments 116. In at least one embodiment, the circuitry 202 may detect the set of objects in the first sequence of video segments 116. Details about the detection of the set of objects are described, for example, in FIG. 1 and FIG. 3.

At 508, a set of embeddings may be generated based on the extracted first sequence of video segments 116 and the set of objects. In at least one embodiment, the circuitry 202 may generate the set of embeddings based on the extracted first sequence of video segments 116 and the detected set of objects. Details about generation of the set of embeddings are described, for example, in FIG. 1 and FIG. 3.

At 510, a PTE model (such as, the PTE model 110) may be applied on the generated set of embeddings. In at least one embodiment, the circuitry 202 may apply the PTE model 110 on the generated set of embeddings. Details about application of the PTE model on the set of embeddings are described, for example, in FIG. 1 and FIG. 3.

At 512, a set of object-action pairs (such as, the set of object-action pairs 120), associated with a second sequence of video segments (such as, the second sequence of video segments 118) of the video content 114, may be predicted based on the application of the PTE model 110. In at least one embodiment, the circuitry 202 may predict, based on the application of the PTE model 110, the set of object-action pairs 120 associated with the second sequence of video segments 118 of the video content 114. Each object-action pair of the predicted set of object-action pairs 120 may include an action that is to be executed using an object of the detected set of objects included in a video segment of the second sequence of video segments 118. The second sequence of video segments 118 may succeed the first sequence of video segments 116 in a playback timeline of the video content 114. Details about the prediction of the set of object-action pairs 120 are described, for example, in FIG. 1 and FIG. 3.

At 514, information associated with the predicted set of object-action pairs 120 and the second sequence of video segments 118 may be rendered. In at least one embodiment, the circuitry 202 may render information associated with the predicted set of object-action pairs 120 and the second sequence of video segments 118. Details about rendering of the information associated with the predicted set of object-action pairs 120 are described, for example, in FIG. 1 and FIG. 3 Control may pass to the end.

Although the flowchart 500 is illustrated as discrete operations, such as 504, 506, 508, 510, 512, and 514, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as the electronic device 102) for generating an object-centric video representation for action prediction. The set of instructions may be executable by the machine and/or the computer to perform operations that may include extraction of a first sequence of video segments (such as the first sequence of video segments 116) from video content (such as the video content 114) associated with a domain. The operations may further include detection of a set of objects in the first sequence of video segments 116. The operations may further include generation of a set of embeddings based on the extracted first sequence of video segments 116 and the detected set of objects. The operations may further include application of a PTE model (such as the PTE model 110) on the generated set of embeddings. The operations may further include prediction, based on the application of the PTE model 110, a set of object-action pairs (such as the set of object-action pairs 120) that may be associated with a second sequence of video segments (such as the second sequence of video segments 118) of the video content 114. Each object-action pair of the predicted set of object-action pairs 120 may include an action that is to be executed using an object of the detected set of objects included in a video segment of the second sequence of video segments 118. The second sequence of video segments 118 may succeed the first sequence of video segments 116 in a playback timeline of the video content 114. The operations may further include rendering of information associated with the predicted set of object-action pairs 120 and the second sequence of video segments 118.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

What is claimed is:

1. An electronic device, comprising:
circuitry configured to:
extract a first sequence of video segments from video content associated with a domain;
detect a set of objects in the first sequence of video segments;
generate a set of embeddings based on the extracted first sequence of video segments and the detected set of objects;
apply a predictive transformer encoder (PTE) model on the generated set of embeddings;
predict, based on the application of the PTE model, a set of object-action pairs associated with a second sequence of video segments of the video content, wherein
each object-action pair of the predicted set of object-action pairs includes an action that is to be executed using an object of the detected set of objects included in a video segment of the second sequence of video segments, and
the second sequence of video segments succeeds the first sequence of video segments in a playback timeline of the video content; and
render information associated with the predicted set of object-action pairs and the second sequence of video segments.

2. The electronic device according to claim 1, wherein the circuitry is further configured to:
train an action prediction model based on the predicted set of object-action pairs and on the second sequence of video segments, wherein
the trained action prediction model is configured to predict human-object interactions from input video frames associated with the domain.

3. The electronic device according to claim 1, wherein the circuitry is further configured to:
receive a user input indicative of a time interval including the first sequence of video segments and the second sequence of video segments, wherein
the prediction of the set of object-action pairs is further based on the time interval.

4. The electronic device according to claim 1, wherein the circuitry is further configured to:
receive a user input indicative of the domain; and
determine a set of domain objects based on the domain indicated in the received user input, wherein
the detected set of objects include domain objects of the determined set of domain objects.

5. The electronic device according to claim 1, wherein the circuitry is further configured to:
receive a user input indicative of a set of domain objects, wherein
the set of domain objects indicated in the received user input is based on the domain, and
the detected set of objects include domain objects of the set of domain objects indicated in the received user input.

6. The electronic device according to claim 1, wherein the circuitry is further configured to:
apply a visual-language model on each video segment of the first sequence of video segments and on information associated with the set of objects to be detected in the first sequence of video segments, wherein
the detection of the set of objects in the first sequence of video segments is further based on the application of the visual-language model.

7. The electronic device according to claim 1, the circuitry is further configured to:
apply a transformer encoder on each video segment of the first sequence of video segments where an object of the set of objects is detected; and
generate a multimodal representation based on the first sequence of video segments and the set of objects, wherein
the multimodal representation corresponds to the set of embeddings.

8. The electronic device according to claim 7, wherein the transformer encoder includes a video encoder and an object encoder.

9. The electronic device according to claim 8, wherein the circuitry is further configured to:
apply the video encoder on each video segment of the first sequence of video segments; and
generate, based on the application of the video encoder, a first subset of embeddings that includes an embedding associated with each video segment of the first sequence of video segments, wherein
the set of embeddings includes the generated first subset of embeddings.

10. The electronic device according to claim 9, wherein each embedding of the first subset of embeddings, associated with each video segment of the first sequence of video segments, is generated based on at least one of:
an object of the set of objects detected in a corresponding video segment,
an action executed by use of the object,
a first time-instance associated with a start of the corresponding video segment, or
a second time-instance associated with an end of the corresponding video segment.

11. The electronic device according to claim 8, wherein the circuitry is further configured to:
apply the object encoder on each video segment of the first sequence of video segments; and
generate, based on the application of the object encoder, a second subset of embeddings that includes an embedding associated with each object of the set of objects, wherein
the set of embeddings includes the generated second subset of embeddings.

12. The electronic device according to claim 11, wherein
each embedding of the second subset of embeddings, associated with an object of the set of objects, is generated based on coordinates of a bounding box that includes the object, and
the coordinates are associated with a video frame of a video segment of the first sequence of video segments where the object is detected.

13. The electronic device according to claim 1, wherein the circuitry is further configured to:
generate a set of features based on the application of the PTE model on the generated set of embeddings, wherein
each feature of the set of features is associated with a video segment of the second sequence of video segments; and
apply a transformer decoder on the generated set of features, wherein
the prediction of the set of object-action pairs is further based on the application of the transformer decoder.

14. The electronic device according to claim 13, wherein the circuitry is further configured to:
generate a third subset of embeddings based on timestamp information associated with each video segment of the second sequence of video segments;
apply the PTE model on a first subset of embeddings associated with the first sequence of video segments, a second subset of embeddings associated with the set of objects, and the third subset of embeddings; and
generate an encoded sequence based on the application of the PTE model, wherein
the generation of the set of features is further based on the generated encoded sequence.

15. The electronic device according to claim 13, wherein the circuitry is further configured to:
determine, for each feature of the generated set of features, a set of candidate object-action pairs; and
determine a confidence score associated with each candidate object-action pair of the determined set of candidate object-action pairs, wherein
the prediction of the set of object-action pairs is further based on the determination of the confidence score associated with each candidate object-action pair.

16. A method, comprising:
in an electronic device:
extracting a first sequence of video segments from video content associated with a domain;
detecting a set of objects in the first sequence of video segments;
generating a set of embeddings based on the extracted first sequence of video segments and the detected set of objects;
applying a predictive transformer encoder (PTE) model on the generated set of embeddings;
predicting, based on the application of the PTE model, a set of object-action pairs associated with a second sequence of video segments of the video content, wherein
each object-action pair of the predicted set of object-action pairs includes an action that is to be executed using an object of the detected set of objects included in a video segment of the second sequence of video segments, and
the second sequence of video segments succeeds the first sequence of video segments in a playback timeline of the video content; and
rendering information associated with the predicted set of object-action pairs and the second sequence of video segments.

17. The method according to claim 16, further comprising:
training an action prediction model based on the predicted set of object-action pairs and on the second sequence of video segments, wherein
the trained action prediction model is configured to predict human-object interactions from input video frames associated with the domain.

18. The method according to claim 16, further comprising:
receiving a user input indicative of the domain; and
determining a set of domain objects based on the domain indicated in the received user input, wherein
the detected set of objects include domain objects of the determined set of domain objects.

19. The method according to claim 16, further comprising:
applying a visual-language model on each video segment of the first sequence of video segments and on information associated with the set of objects to be detected in the first sequence of video segments, wherein
the detection of the set of objects in the first sequence of video segments is further based on the application of the visual-language model.

20. A non-transitory computer-readable medium having stored thereon, computer-executable instructions that when executed by an electronic device, causes the electronic device to execute operations, the operations comprising:
extracting a first sequence of video segments from video content associated with a domain;
detecting a set of objects in the first sequence of video segments;
generating a set of embeddings based on the extracted first sequence of video segments and the detected set of objects;
applying a predictive transformer encoder (PTE) model on the generated set of embeddings;
predicting, based on the application of the PTE model, a set of object-action pairs associated with a second sequence of video segments of the video content, wherein
each object-action pair of the predicted set of object-action pairs includes an action that is to be executed using an object of the detected set of objects included in a video segment of the second sequence of video segments, and
the second sequence of video segments succeeds the first sequence of video segments in a playback timeline of the video content; and
rendering information associated with the predicted set of object-action pairs and the second sequence of video segments.
